(19) United States
(12) Patent Application Publication
(10) Pub. No.: US 2026/0169335 A1
(43) Pub. Date: Jun. 18, 2026

(54) Display Panel and Display Device

(71) Applicants: Chongqing BOE Optoelectronics Technology Co., Ltd., Chongqing (CN); BOE Technology Group Co., Ltd., Beijing (CN)

(72) Inventors: Xiongzhou WEI, Beijing (CN); Xiaofeng YIN, Beijing (CN); Min LI, Beijing (CN)

(21) Appl. No.: 18/713,710

(22) PCT Filed: Aug. 14, 2023
(86) PCT No.: PCT/CN2023/112943

§ 371 Date: May 28, 2024

(51) Int. Cl. G02F 1/1362; G02F 1/1335; G02F 1/1337; G02F 1/1339

(52) U.S. Cl. CPC G02F 1/136286; G02F 1/133514; G02F 1/133707; G02F 1/13394

(57) ABSTRACT

Disclosed in contents of the present disclosure are a display panel and a display device, wherein the display panel includes an array substrate (10) and a color film substrate (20) disposed oppositely, and a Liquid Crystal layer (LC) between the array substrate (10) and the color film substrate (20); a liquid crystal cell gap of the Liquid Crystal layer (LC) in a light transmission region of the display panel satisfies: when a refresh rate of the display panel is greater than or equal to 60 Hz and does not exceed 480 Hz, a reciprocal of the refresh rate of the display panel conforms to a quadratic polynomial relationship with the liquid crystal cell gap. The liquid crystal cell gap of the display panel is only related to the refresh rate of the display panel, thereby having more simplified design complexity and higher design efficiency.

### CROSS-REFERENCE TO RELATED APPLICATION

The present application is a U.S. National Phase Entry of International Application No. PCT/CN2023/112943 having an international filing date of Aug. 14, 2023. Contents of the above-identified application should be interpreted as being incorporated into the present application by reference.

### TECHNICAL FIELD

The present disclosure relates to a display panel and a display device.

### BACKGROUND

With continuous development of Thin Film Transistor Liquid Crystal Display products (TFT-LCD) and continuous improvement of users' requirements for display quality, a demand for a product with a high refresh rate is increasing day by day. While a high refresh rate requires a lower liquid crystal Cell Gap.

A Cell Gap is aimed for measuring an opening region, but it is difficult to measure in a Post Spacer (PS) region because it is opaque. For an LCD product, a Cell Gap has many influencing factors, including a TFT Pillow (a height difference between a standing position or setting position of a Post Spacer (PS) on a TFT substrate and a Pixel light transmission region), a color resistance segment difference of a Color Film substrate (CF), a Post Spacer (PS) height, and an internal liquid crystal amount, etc. Excessive influencing factors lead to increase of complexity and decrease of design accuracy of the Cell Gap; since a liquid crystal display product with a high refresh rate needs a lower Cell Gap, the decrease of the design accuracy of the Cell Gap will significantly affect a design efficiency of a display product adversely.

### SUMMARY

An object of contents of the present disclosure is at least partly to provide a display panel and a display device, which at least to some extent solve a technical problem that a design efficiency of a display product is reduced due to a complicated design and low precision of a liquid crystal cell gap.

In a first aspect, the present disclosure provides a display panel including an array substrate and a color film substrate disposed oppositely, and a liquid crystal layer between the array substrate and the color film substrate; wherein a liquid crystal cell gap of the liquid crystal layer in a light transmission region of the display panel satisfies: when a refresh rate of the display panel is greater than or equal to 60 Hz and does not exceed 480 Hz, a reciprocal of the refresh rate of the display panel conforms to a quadratic polynomial relation with the liquid crystal cell gap.

In some embodiments, the liquid crystal cell gap and the refresh rate satisfy a following formula.

$$1 / f = {C}_{2} \times {d}^{2} + {C}_{1} \times d + {C}_{0}$$

f in the above formula is the refresh rate, and a unit is Hz; d is the liquid crystal cell gap, and a unit is μm; a value range of C₂ is 0.003 to 0.004, a value range of C₁ is −0.02 to −0.01, and a value range of C₀ is 0.01 to 0.02.

In some embodiments, when the refresh rate of the display panel is greater than 480 Hz and does not exceed 1000 Hz, a value range of the liquid crystal cell gap is 1.044 μm to 1.6 μm.

In some embodiments, the array substrate includes a first substrate and a first post spacer layer, the first post spacer layer is disposed on a side of the first substrate close to the color film substrate; the color film substrate includes a second substrate and a second post spacer layer, the second post spacer layer is disposed on a side of the second substrate close to the array substrate; the first post spacer layer includes at least one first main post spacer and a plurality of first sub post spacers, wherein the first main post spacer and the first sub post spacers are disposed at intervals; the second post spacer layer includes at least one second main post spacer and a plurality of second sub post spacers, wherein the second main post spacer and the second sub post spacers are disposed at intervals; the first main post spacer is butted against the second main post spacer, and the first sub post spacers and the second sub post spacers are disposed oppositely.

In some embodiments, the array substrate further includes a colorresist layer and an organic film layer stacked on the first substrate, and the organic film layer is located between the colorresist layer and the first post spacer layer.

In some embodiments, the organic film layer is provided with a first groove, a first sub post spacer is disposed within the first groove, and the first main post spacer is disposed on the organic film layer outside the first groove.

In some embodiments, the second main post spacer and the second sub post spacers include a black matrix layer, and the color film substrate includes an over coat covering the black matrix layer and the second substrate; in a direction perpendicular to the second substrate, a thickness of the black matrix layer is greater than a thickness of the over coat covering the second substrate, and the over coat on the second main post spacer is butted against the first main post spacer.

In some embodiments, a deviation between a sum of thicknesses of the black matrix layer in the second main post spacer, and the over coat after cell-assembling, and a height of the first main post spacer after cell-assembling, is not more than 20%.

In some embodiments, the color film substrate includes a black matrix layer and an over coat disposed on a side of the second substrate close to the array substrate, and the black matrix layer is located between the second substrate and the over coat; the over coat is provided with a second groove, a second sub post spacer is disposed within the second groove, and the second main post spacer is disposed on the over coat outside the second groove.

In some embodiments, the color film substrate includes a black matrix layer and a colorresist layer disposed in a same layer on the second substrate, and an over coat covering the black matrix layer and the colorresist layer; the second main post spacer and the second sub post spacers are disposed on the over coat, and an orthographic projection on the second substrate is located within an orthographic projection of the black matrix layer on the second substrate; in a direction perpendicular to the second substrate, a sum of thicknesses of the black matrix layer and the over coat is less than a sum of thicknesses of the colorresist layer and the over coat.

In some embodiments, in a vertical direction of the color film substrate, top surfaces of the second sub post spacers are lower than a top surface of the second main post spacer, and height differences are 0.45 μm to 0.55 μm; or, in a vertical direction of the array substrate, top surfaces of the first sub post spacers are lower than a top surface of the first main post spacer, and height differences are 0.45 μm to 0.55 μm.

In some embodiments, a sum of a product of a height of the first main post spacer before cell-assembling and a compression ratio after cell-assembling, and a height of the second main post spacer after cell-assembling, is equal to the liquid crystal cell gap, and a value range of the compression ratio is 0.86 to 0.88.

In some embodiments, a deviation between a height of the first main post spacer after cell-assembling and a height of the second main post spacer after cell-assembling is not more than 10%.

In some embodiments, the first main post spacer and the first sub post spacers have a same height, and heights of the second sub post spacers are lower than a height of the second main post spacer; or, the second sub post spacers and the second main post spacer have a same height, and heights of the first sub post spacers are lower than a height of the first main post spacer.

In a second aspect, the present disclosure provides a display device including any display panel provided by embodiments of the first aspect.

A liquid crystal cell gap of the display panel provided by the present disclosure is designed that when a refresh rate of the display panel is greater than or equal to 60 Hz and does not exceed 480 Hz, the liquid crystal cell gap is designed to satisfy a quadratic polynomial relationship with a reciprocal of the refresh rate of the display panel; by constructing a quadratic polynomial fitting relationship between the liquid crystal cell gap and the reciprocal of refresh rate, compared with a conventional design of a liquid crystal cell gap according to a TFT Pillow, a color resistance segment difference, a post spacer height, and a liquid crystal amount, influencing factors of the liquid crystal cell gap are significantly reduced, which is beneficial to reduce design complexity and improve design accuracy of the liquid crystal cell gap, thus improving a design efficiency of a liquid crystal product.

The above description is only an overview of technical schemes of the present disclosure, which may be implemented according to contents of the specification in order to be able to understand technical means of the present disclosure more clearly, and in order to make the above and other objects, features, and advantages of the present disclosure more obvious and understandable, specific embodiments of the present disclosure are set forth below.

### BRIEF DESCRIPTION OF DRAWINGS

FIG. 1 is a schematic diagram of a testing principle of a liquid crystal cell gap.

FIG. 2 is a schematic diagram of a display panel according to an embodiment of the present disclosure.

FIG. 3 is a schematic diagram of fitting of a refresh rate and a liquid crystal cell gap according to an embodiment of the present disclosure.

FIG. 4 is a schematic diagram of Sub Post Spacer (Sub PS) missing according to an embodiment of the present disclosure.

FIG. 5 is a schematic diagram of a display panel with a cross Post Spacer (XPS) design according to an embodiment of the present disclosure.

FIG. 6 is a schematic diagram of an arrangement of a first main PS and a first Sub PS according to an embodiment of the present disclosure.

FIG. 7 is a schematic diagram of a film layer structure of a display panel designed by combining XPS with Color Filter on Array (COA) according to an embodiment of the present disclosure.

FIG. 8A is a schematic diagram of disposing a first Sub PS within a first groove according to an embodiment of the present disclosure.

FIG. 8B is a schematic diagram of disposing a first main PS and a first Sub PS within a first groove according to an embodiment of the present disclosure.

FIG. 9 is a schematic diagram of forming a second PS layer through a black matrix layer and an over coat according to an embodiment of the present disclosure.

FIG. 10 is a schematic diagram of disposing a second Sub PS within a second groove according to an embodiment of the present disclosure.

FIG. 11 is a microstructure photograph of a second Sub PS according to an embodiment of the present disclosure.

FIG. 12 is a structural design of a PS at a CF side of an XPS display panel according to an embodiment of the present disclosure.

FIG. 13 is a schematic diagram of a display device according to an embodiment of the present disclosure.

Reference signs are as follows.

10: array substrate; 11: first substrate; 12: first groove; 20: color film substrate; 21: second substrate; 22: second groove; BM: Black Matrix layer; OC: planarization protective layer (Over Coat); CRL: Colorresist Layer; ORG: Organic film layer; PS1: first PS layer; Main PS1: first Main PS; Sub PS1: first Sub PS; PS2: second PS layer; Main PS2: second Main PS; Sub PS2: second Sub PS.

### DETAILED DESCRIPTION

For the contents of the present disclosure, hereinafter, embodiments of the present disclosure will be described with reference to the drawings. However, it should be understood that these descriptions are exemplary only and are not intended to limit the scope of the present disclosure. In addition, in following description, descriptions of well-known structures and technologies are omitted to avoid unnecessarily confusing concepts of the present disclosure.

Schematic diagrams of various structures according to the embodiments of the present disclosure are shown in the drawings. These drawings are not drawn to scale, in which some details are enlarged and may be omitted for a purpose of clear expression. Shapes of various regions and layers, and relative sizes and positional relationships between them shown in the drawings are only exemplary, and may be deviated in practice due to manufacturing tolerances or technical limitations, and those skilled in the art may additionally design regions/layers having different shapes, sizes, relative positional relationships according to actual needs.

In the context of the present disclosure, when one layer/element is referred to as “on” another layer/element, the layer/element may be directly on another layer/element, or a middle layer/element may exist between them. In addition, if one layer/element is “above” another layer/element in one orientation, the layer/element may be “below” another layer/element when the orientation is reversed.

In the context of the present disclosure, unless otherwise specified, a light emitting side of a display panel is a “top side” or “upper side”, and an opposite side is a “bottom side” or “lower side” to facilitate description of a relative direction. Accordingly, a direction from the bottom side to the top side is a thickness direction of the display panel, and a direction perpendicular to the thickness direction is a “plane direction” or “extension direction” of the display panel. It should be understood that these directions are relative directions rather than absolute directions.

Unless otherwise defined, technical terms or scientific terms used in the present disclosure should have meanings as commonly understood by those of ordinary skills in the art that the present disclosure belongs to. “First”, “second”, and similar words used in the present disclosure do not indicate any order, quantity, or importance, but are used only for distinguishing different components. Similarly, similar words such as “a”, “an”, or “the” do not denote a limitation on quantity, but rather denote presence of at least one. “Include”, “contain”, or similar words mean that elements or objects appearing before the words cover elements or objects listed after the words and their equivalents, but do not exclude other elements or objects. “Connect”, “couple”, or a similar word is not limited to a physical or mechanical connection, but may include an electrical connection, whether direct or indirect. “Upper”, “lower”, “left”, and “right”, etc., are only used for representing relative positional relationships, and when an absolute position of a described object is changed, a relative positional relationship may also be correspondingly changed.

A Cell Gap is an important parameter in a TFT-LCD design. With development of the industry and improvement of quality technologies, liquid crystal display products with a high refresh rate and an extremely low Cell Gap came into being, which brought challenges to a design of the Cell Gap.

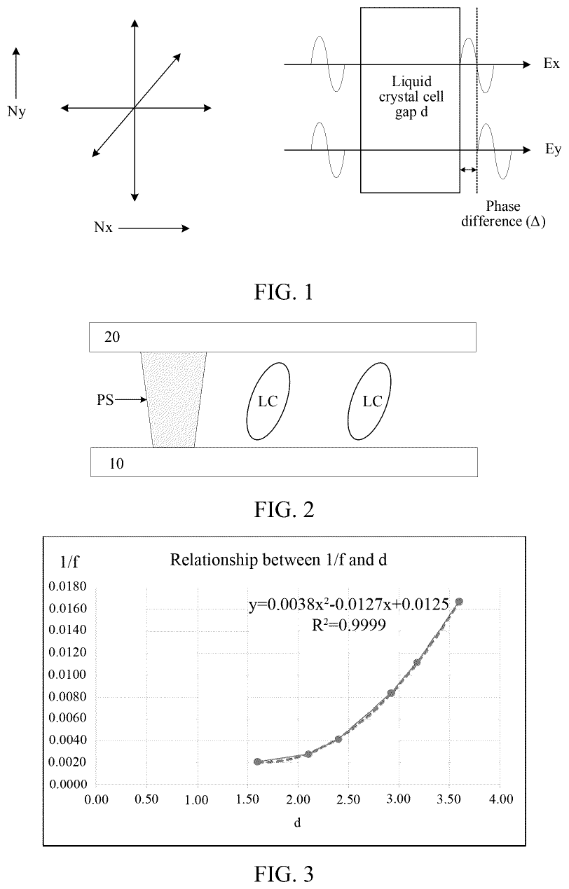

A measurement principle of the Cell Gap is shown in FIG. 1. After light is projected to a liquid crystal cell, linearly polarized light changes into elliptical light due to a birefringence effect of liquid crystal, because there is a phenomenon of a phase difference between x and y directions of light. A magnitude of phase deviation is determined by a liquid crystal cell gap d and a refractive index difference Δn, and a relationship expression is as follows.

$$Re = Δ n \times d \qquad ( 1 )$$

Therefore, a solution formula of the liquid crystal cell gap d is as follows.

$$d = Re / Δ n \qquad ( 2 )$$

Re in the above formula is a birefringence phase difference (Retardation), which means that when linearly polarized light E is incident at a fixed angle, phases of decomposition vectors Ex and Ey are the same before incidence, and after the light passes through a sample, a phase change caused by a difference in refractive indices of x and y is called the birefringence Retardation. Δn=Ne−No, Ne and No are characteristic parameters of a liquid crystal material.

A flow of measuring a liquid crystal cell gap by a system is as follows: spectral measurement of elliptically polarized light→analysis of Re values at intervals of 10 nm within a wavelength range from 400 nm to 800 nm→calculation of a Fitting formula for the above data using the least square method, and determination of Re at any wavelength.

A design of the liquid crystal cell gap is related to a structural design of a Post Spacer (PS). According to the structural design of the PS, it may be divided into an ordinary panel and an XPS panel. In a manufacturing process of an ordinary liquid crystal display panel, it is necessary to manufacture an array substrate (TFT) and a Color Film substrate (CF) respectively, and then edges of the color film substrate and the array substrate are bonded together through a frame sealing glue, and liquid crystal is filled in a region sealed by the frame sealing glue to achieve manufacturing of a liquid crystal display apparatus; among them, a Post Spacer (PS) which plays a supporting role is disposed in a pixel region for display and between the pixel region and the frame sealing glue, and the PS is usually disposed on the color film substrate. For a liquid crystal display panel manufactured using an XPS technology, a layer of Post Spacer (PS) is formed on the color film substrate and the array substrate respectively and butted against each other. In some embodiments, the two PS butted against each other on the array substrate and the color film substrate, are set to at approximately equal heights. In some embodiments, cross sections of the two PS butted against each other on the array substrate and the color film substrate in a direction parallel to the display panel are both set to be in a strip shape and crossed to optimize PS Mura (non-uniform) and a panel strength.

A design of a liquid crystal Cell Gap of an XPS-designed liquid crystal display product is as follows.

$$Call Gap = P S H \times 2 \times P S compression ratio - pixel segment difference + T F T Pillow \qquad ( 3 )$$

The Post Spacer Height (PSH) in the above formula is a free height of a Post Spacer (PS) on an array substrate side (TFT side) or the color film substrate (CF side) before cell-assembling, and both are of an equal height design; the PS compression ratio is a compression ratio of the Post Spacer (PS), for example, an optional value of the compression ratio is about 87%; the pixel segment difference is a pixel segment difference of a sub-pixel RGB after OC (planarization protective layer), which is a segment difference between the sub-pixel RGB and a black matrix; the TFT Pillow is a height difference between a setting position of a Post Spacer (PS) on a TFT substrate and a Pixel light transmission region.

At present, an extremely low PSH technology may reduce a height of a unilateral post spacer of an XPS product to 0.9 μm, that is, a unilateral PSH is >0.9 μm. According to the formula (3) and common values of the pixel segment difference and the TFT Pillow, it may be known that a liquid crystal cell gap of an XPS liquid crystal display panel will not be less than 1.57 μm.

For an ordinary liquid crystal display product, a design of a liquid crystal cell gap is as follows.

$$Call Gap = P S H \times compression ratio - pixel segment difference + T F T Pillow \qquad ( 4 )$$

Among them, the Post Spacer Height (PSH) is a height of a Post Spacer (PS) on a color film substrate side. Similarly, the PSH is not less than 0.9 μm, and it may be determined that a liquid crystal cell gap of an ordinary liquid crystal display panel is not less than 0.78 μm.

According to the above contents, there are many influencing factors affecting the Cell Gap, including a TFT Pillow, a CF color resistance segment difference, and a post spacer height, etc. In addition, an amount of internal liquid crystal is also one of the influencing factors. With development of high-refresh display products, a smaller Cell Gap is needed, so a deviation of design accuracy of the Cell Gap has a more significant impact on high-refresh display products.

In order to solve the above problem, in a first aspect, referring to FIG. 2, the present disclosure provides a display panel including an array substrate 10 and a color film substrate 20 that are disposed oppositely, and a liquid crystal layer LC located between the array substrate 10 and the color film substrate 20; a liquid crystal cell gap of the liquid crystal layer LC in a light transmission region of the display panel satisfies that when a refresh rate of the display panel is greater than or equal to 60 Hz and does not exceed 480 Hz, a reciprocal of the refresh rate of the display panel conforms to a quadratic polynomial relationship with the liquid crystal cell gap.

A source of an idea for determining the relationship between the liquid crystal cell gap and the refresh rate provided by the embodiment of the present disclosure is as follows: the higher the refresh rate of the display panel means that a shorter or faster response time is required; the response time is a time for a liquid crystal display to respond to an input signal, that is, a time required for a pixel to turn from dark to bright or from bright to dark. The shorter the response time, the faster a response speed, and the smoother a screen switching.

A formula of the response time is as follows.

$${τ}_{r} = \frac{{γ}_{1} {d}^{2}}{Δ ε ( {V}^{2} - {V}_{th}^{2} )} \qquad ( 5 )$$

$${τ}_{d} = \frac{{γ}_{1} {d}^{2}}{Δ ε {V}_{th}^{2}} \qquad ( 6 )$$

In formulas (5) and (6): τᵣ is a rising time, which indicates a time interval of brightness dropping from 90% to 10% (normally white mode) or a time interval rising from 10% to 90% (normally black mode) in a process from a power-off state to a power-on state; τ_{d} is a delay time, which indicates a time interval when brightness reaches 10% of maximum brightness during power failure.
γ₁: a viscosity coefficient of a liquid crystal material.
d: a liquid crystal cell gap.
V: a drive voltage.
Vₜₕ: a threshold voltage.
Δε: a dielectric coefficient of the liquid crystal material.

Making τₒₙ=τᵣ+τ_{d}, and a refresh rate is f, there is a following formula.

$$1 / f = k {τ}_{on} = k {γ}_{1} {d}^{2} [ \frac{1}{Δ ε ( {V}^{2} - {V}_{th}^{2} )} + \frac{1}{Δ ε {V}_{th}^{2}} ] \qquad ( 7 )$$

$$Namely :$$

$${τ}_{on . off} ∝ \frac{{γ}_{1} {d}^{2}}{K} \qquad ( 8 )$$

It may be seen that under a premise that the liquid crystal material and the drive voltage are the same, a response time τ_{on. off} is proportional to a square of a liquid crystal cell gap d, and the refresh rate is inversely correlated with the square of d.

Combining the above theoretical derivation, a liquid crystal cell gap design, analog simulation, and data verification are carried out. By integrating data, when the refresh rate is in a range of [60 Hz, 480 Hz], a following fitting relationship is obtained.

$$1 / f = {C}_{2} \times {d}^{2} + {C}_{1} \times d + {C}_{0} \qquad ( 9 )$$

f in the above formula is a refresh rate, and a unit is Hz; d is a liquid crystal cell gap, and a unit is μm; a value range of C₂ is [0.003, 0.004], a value range of C₁ is [−0.02, −0.01], and a value range of C₀ is [0.01, 0.02].

Optionally, values of coefficient terms are: C₂=0.0038, C₁=−0.0127, C₂=0.0125, that is, a following formula is satisfied.

$$1 / f = 0.0038 {d}^{2} - 0.0127 d + 0.0125 \qquad ( 10 )$$

A determining coefficient R² of a fitting relationship of the formula (10) is 0.9999, as shown in FIG. 3; a numerical value of the determining coefficient R² reflects a fitting degree between an estimated value of a trend line and corresponding actual data. When a square value of R is equal to or close to 1, it indicates reliability if the highest, otherwise, the reliability is relatively low.

According to formulas (9) and (10), a liquid crystal cell gap of the display panel provided by the present disclosure is designed that a quadratic polynomial fitting relationship between a reciprocal of a refresh rate and the liquid crystal cell gap is constructed when the refresh rate of the display panel is greater than or equal to 60 Hz and does not exceed 480 Hz. Compared with a conventional design of a liquid crystal cell gap according to a TFT Pillow, a color resistance segment difference, a post spacer height, and a liquid crystal amount, influencing factors of the liquid crystal cell gap are significantly reduced, design complexity of the liquid crystal cell gap is reduced, and design accuracy is improved, thereby improving a design efficiency of a liquid crystal display product and providing a new Cell Gap design benchmark.

Optionally, for a high-refresh display product with a refresh rate f greater than 480 Hz, such as [480 Hz, 1000 Hz], a value range of a liquid crystal cell gap is [1.044 μm, 1.6 μm], and a trend is that the higher the refresh rate is, the smaller a value of the liquid crystal cell gap is. In some embodiments, on a premise of satisfying the refresh rate, a higher liquid crystal cell gap may also be selected, and the higher the liquid crystal cell gap is, the higher a product transmittance is. In addition, the liquid crystal cell gap may also be adjusted according to a customer's demand for a gray scale response time (Gray to Gray (GTG)). According to a corresponding relationship between the liquid crystal cell gap and the refresh rate of the embodiment of the present disclosure, the liquid crystal cell gap ranges from 1.044 μm to 3.8 m.

The corresponding relationship between the liquid crystal cell gap and the refresh rate provided by the embodiment of the present disclosure may be used for a common liquid crystal display panel, or may be used for an XPS liquid crystal display panel. Taking an XPS liquid crystal display product used for a notebook computer (NB) as an example, a common refresh rate ranges from 60 Hz to 360 Hz, and >120 Hz is a high-refresh product. A requirement of a liquid crystal cell gap of the high-refresh product is also related to a response time. When a liquid crystal material is determined, the faster the response time is and the higher the refresh rate is, then the lower the liquid crystal cell gap is.

Liquid crystal cell gaps of some XPS liquid crystal display products are designed as follows: a liquid crystal cell gap corresponding to a 60 Hz NB product is about 3.6 μm, a liquid crystal cell gap corresponding to a 90 Hz NB product is about 3.18 μm, a liquid crystal cell gap corresponding to a 120 Hz NB product is about 2.92 μm, a liquid crystal cell gap corresponding to a 240 Hz NB product is about 2.4 μm (GTG is 3 ms), a liquid crystal cell gap corresponding to a 360 Hz NB product is about 2.0 am (GTG is 2 ms), and a liquid crystal cell gap corresponding to a 480 Hz NB product is about 1.6 μm (GTG is 1 ms).

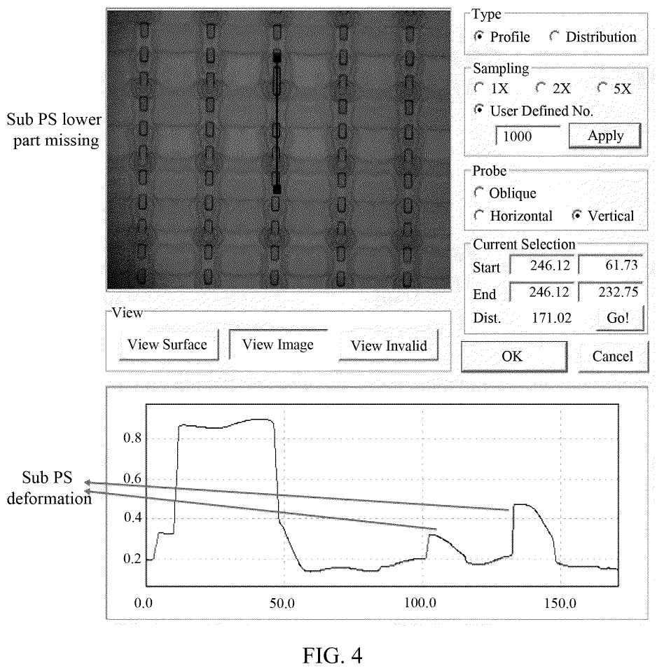

In order to ensure a sufficient liquid crystal safety range (LC Margin) of a display screen, for an XPS liquid crystal display panel, a Main Post Spacer (Main PS) and a Sub Post Spacer (Sub PS) may be disposed in PS layers of a TFT side and a CF side respectively, wherein the Sub PS is thinner in size or lower in height; however, if the Sub PS is too thin or too low, a problem of Sub PS missing, morphological deformation, or molding failure easily occurs, as shown in FIG. 4. In order to avoid presence of Sub PS missing, a height thereof should be controlled above 0.5 μm. Therefore, the liquid crystal cell gap cannot be infinitely reduced, and if it is too small, it is easy to produce a problem such as PS missing during fabrication. At present, an extremely low PSH technology may reduce a height of a Main PS of an XPS product to 0.9 μm while ensuring that a Sub PS is not missing.

For an XPS liquid crystal display panel, on one hand, PS layers are designed on a TFT side and a CF side respectively, which reduces a height of a PS layer on one side; on the other hand, due to increase of a refresh rate, it is required to further reduce a liquid crystal cell gap, so it is necessary to further reduce the height of the PS layer on one side; as before, if the height of the PS layer is too low, a process ability cannot be met, and a problem of PS missing is easy to occur, so a design of the liquid crystal cell gap will be limited.

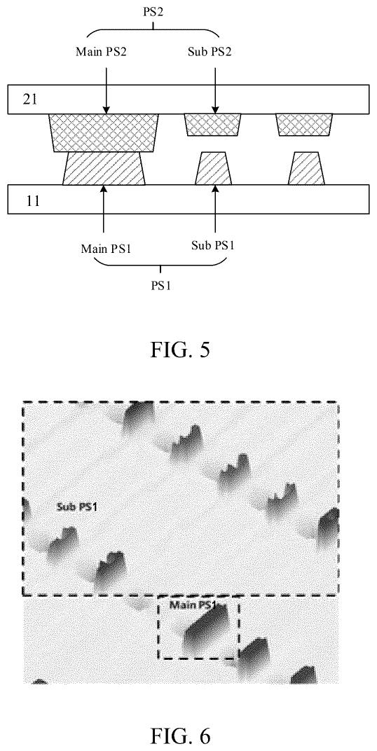

In order to solve the above problem, in some embodiments, referring to a liquid crystal display panel with an XPS structure provided in FIG. 5, a combined structure of a Main Post Spacer (Main PS) and a Sub Post Spacer (Sub PS) is used for forming a post spacer layer, including: an array substrate 10 includes a first substrate 11 and a first post spacer layer PS1, wherein the first post spacer layer PS1 is disposed on a side of the first substrate 11 close to a color film substrate 20; the color film substrate 20 includes a second substrate 21 and a second post spacer layer PS2, wherein the second post spacer layer PS2 is disposed on a side of the second substrate 21 close to the array substrate 10; the first post spacer layer PS1 includes at least one first main post spacer Main PS1 and a plurality of first sub post spacers Sub PS1, wherein the first main post spacer Main PS1 and the first sub post spacers Sub PS1 are disposed at intervals; the second post spacer layer PS2 includes at least one second main post spacer Main PS2 and a plurality of second sub post spacers Sub PS2, wherein the second main post spacer Main PS2 and the second sub post spacers Sub PS2 are disposed at intervals; the first main post spacer Main PS1 is butted against the second main post spacer Main PS2, and the first sub post spacers Sub PS1 and the second sub post spacers Sub PS2 are disposed oppositely.

In some embodiments, the first substrate 11 is a base of the array substrate 10, also referred to as a base substrate or a TFT substrate, and a transparent glass substrate TFT Glass may be used; the second substrate 21 is a base of the color film substrate 20, also referred to as a CF substrate, similarly a transparent glass substrate CF Glass may also be used.

Optional designs for structures of a main post spacer and a sub post spacer include: \textcircled{1} when a PS segment difference is formed on a color film substrate 20 side (CF), as shown in FIG. 5, post spacers on a TFT side are equal in height, that is, heights of the first main post spacer Main PS1 and a first sub post spacer Sub PS1 are equal, and the first main post spacer Main PS1 may be designed to be more robust than the first sub post spacer Sub PS1; post spacers on the CF side are not equal in height, and a height of a second sub post spacer Sub PS2 is lower than that of the second main post spacer Main PS2; after a liquid crystal panel is cell-assembled, the first main post spacer Main PS1 and the second main post spacer Main PS2 are disposed to be butted against each other, and the first sub post spacer Sub PS1 and the second sub post spacer Sub PS2 are disposed oppositely; \textcircled{2} When a PS segment difference is formed on an array substrate 10 side (TFT), post spacers on the CF side are equal in height, that is, heights of the second main post spacer Main PS2 and a second sub post spacer Sub PS2 are equal, and the second main post spacer Main PS2 is more robust than the second sub post spacer Sub PS2; post spacers on the TFT side are not equal in height, and a height of a first sub post spacer Sub PS1 is lower than that of the first main post spacer Main PS1; after the liquid crystal panel is cell-assembled, the first main post spacer Main PS1 and the second main post spacer Main PS2 are disposed to be butted against each other, and the first sub post spacer Sub PS1 and the second sub post spacer Sub PS2 are disposed oppositely.

Taking the first main post spacer Main PS1 and the first sub post spacer Sub PS1 as examples, the more robust first main post spacer Main PS1 means that a cross-sectional area of the first main post spacer Main PS1 is larger than that of the first sub post spacer Sub PS1 in a plane direction of the display panel. Both the first main post spacer Main PS1 and the first sub post spacer Sub PS1 may be designed to have a columnar structure, and a cross section of the columnar structure may be a triangle, a polygon, a circle, and an ellipse, etc., which may be designed according to actual requirements; the first main post spacer Main PS1 and the first sub post spacer Sub PS1 are disposed at intervals, it may be that a plurality of first sub post spacers Sub PS1 are arranged between two first main post spacers Main PS1, as shown in FIG. 6; or a plurality of first main post spacers Main PS1 are arranged between two first sub post spacers Sub PS1. A preferred scheme is the former, and a quantity ratio of the first main post spacer Main PS1 to the first sub post spacer Sub PS1 may be determined according to actual requirements. For example, a quantity ratio of the first main post spacer Main PS1 to the first sub post spacer Sub PS1 is set to 1:10 to 300, which is not limited in the embodiment of the present disclosure.

When shapes of the first main post spacer Main PS1, the first sub post spacer Sub PS1, the second main post spacer Main PS2, and the second sub post spacer Sub PS2 are designed using the above scheme, a liquid crystal safety range (LC margin) of a display screen of a liquid crystal display panel can be further increased.

In some embodiments, shapes of the first main post spacer Main PS1 and the first sub post spacer Sub PS1 on the TFT side and the second main post spacer Main PS2 and the second sub post spacer Sub PS2 on the CF side may be strip-shaped, and their arrangement directions may be intersected with each other, such as the first main post spacer Main PS1 and the second main post spacer Main PS2 that are butted, which are arranged in a cross shape perpendicular to each other or in a non-cross shape not perpendicular to each other, and the first sub post spacer Sub PS1 and the second sub post spacer Sub PS2, which are opposite to each other, are arranged in a cross shape or in a non-cross shape, thus a problem of PS mura can be further optimized and a panel strength can be improved.

The above scheme provides an overall design of a post spacer structure in the XPS liquid crystal display panel. Next, film layer structures on the TFT side and the CF side are further described respectively.

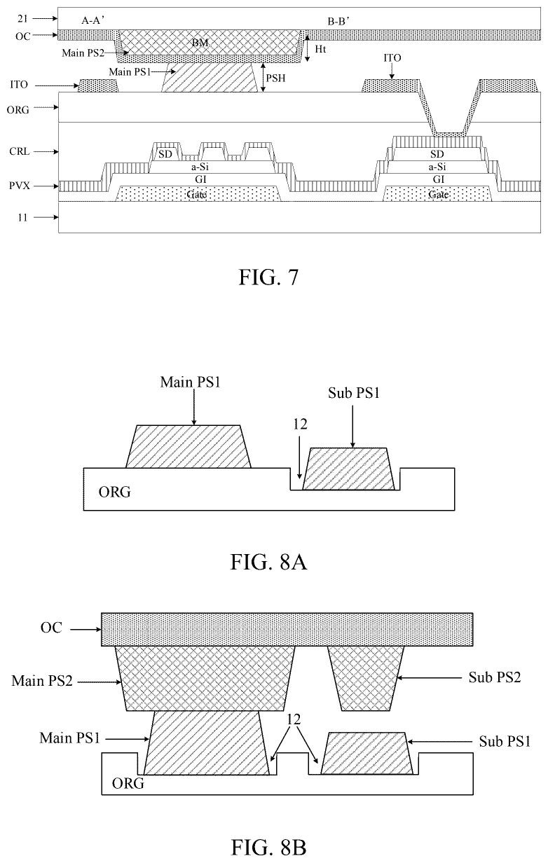

For a film layer structure on the TFT side, in some embodiments, referring to a schematic diagram of a stacked structure of the display panel shown in FIG. 7, the array substrate 10 further includes a Colorresist Layer (CRL) and an Organic film layer (ORG) stacked on the first substrate 11, and the Organic film layer (ORG) is located between the Colorresist Layer (CRL) and the first post spacer layer PS1. That is to say, the array substrate 10 provided herein is a Color Filter on Array (COA) substrate, which is a technology for integrating the Organic film layer (ORG) and the Colorresist Layer (CRL) on the array substrate 10. An advantage of the COA substrate is that there is no light leakage problem caused by cell-assembling, and a width of a Black Matrix layer (BM) may be effectively reduced, thus improving a pixel aperture ratio and further improving a transmittance of the display panel.

For the COA substrate, referring to FIG. 7, in a thickness direction, the display panel includes a Gate metal layer Gate, a Gate dielectric layer GI, an amorphous silicon active layer a-Si, a source-drain metal layer SD, and a Passivation layer PVX, which are sequentially laminated on the first substrate 11 (TFT substrate). These film layer structures form a thin film transistor located in a display region A-A′ and a thin film transistor located in a peripheral region B-B′. Then, a Colorresist Layer (CRL) and an Organic film layer (ORG) are sequentially stacked on the passivation layer. Among them, a Colorresist Layer (CRL) located in a blue sub-pixel region is a Blue Colorresist Layer (B-CRL), a Colorresist Layer (CRL) located in a green sub-pixel region is a Green Colorresist Layer (G-CRL), and a Colorresist Layer (CRL) located in a red sub-pixel region is a Red Colorresist Layer (R-CRL). A Colorresist Layer (CRL) and an Organic film layer (ORG) constitute a color light-filtering film layer, which achieves light filtering on one hand and achieves planarization of an opening region on the other hand. The first post spacer layer PS1 on the TFT side is disposed on a side of the Organic film layer (ORG) close to the color film substrate 20. In addition, an Indium Tin Oxide (ITO) transparent electrode is also laminated on the Organic film layer (ORG).

Since a RGB color light-filtering film layer in the COA substrate is disposed on one side of the TFT substrate and planarization is performed through the Organic film layer (ORG), a pixel segment difference may not be considered for a position of a post spacer layer and a position of a pixel opening region on the TFT side.

It should be noted that in the COA substrate, the Colorresist Layer (CRL) is integrated into the TFT side of the array substrate 10. Although no color light-filtering layer is disposed on the color film substrate 20 side, which will still be referred to as the CF side in following contents for convenience of describing and distinguishing the array substrate 10 on the TFT side.

In some embodiments, referring to FIG. 8A, the Organic film layer (ORG) is provided with a first groove 12, a first sub post spacer Sub PS1 is disposed within the first groove 12, and a first main post spacer Main PS1 is disposed on the Organic film layer (ORG) outside the first groove 12. Among them, the first groove 12 may be a blind hole formed by digging a groove on the Organic film layer (ORG), or may be a through hole penetrating through the Organic film layer (ORG), and then a post spacer material is deposited to form a first sub post spacer PS1 within the through hole or the blind hole, and a first main post spacer Main PS1 is formed on the Organic film layer (ORG) other than the through hole or the blind hole. By forming the first sub post spacer Sub PS1 within the first groove 12, on one hand, a top surface of the first sub post spacer Sub PS1 may be made lower than a top surface of the first main post spacer Main PS1 in a vertical direction of the array substrate 10, thereby forming a certain PS segment difference between the first main post spacer Main PS1 and the first sub post spacer Sub PS1, such as 0.45 μm to 0.55 μm, a better value is 0.5 μm. When this segment difference is met again, a first post spacer layer PS1 may be manufactured by using a Normal Mask instead of a Halftone Mask, thereby saving a Mask manufacturing cost; on the other hand, while maintaining the PS segment difference and further reducing a liquid crystal cell gap, a height of the first sub post spacer Sub PS1 can be ensured not to be too low, thus avoiding a problem of PS missing caused by a too low first sub post spacer Sub PS1.

In some embodiments, referring to FIG. 8B, more first grooves 12 may be disposed on the Organic film layer (ORG), both the first main post spacer Main PS1 and the first sub post spacer Sub PS1 are disposed within the first grooves 12, and the first main post spacer Main PS1 and the first sub post spacer Sub PS1 form a PS segment difference. At this time, an equal height design or approximate equal height design may be adopted for the second main post spacer Main PS2 and the second sub post spacer Sub PS2 on the CF side, in this way, it may be similarly achieved that the first post spacer layer PS1 is manufactured by using the Normal Mask instead of the Halftone Mask, and the liquid crystal cell gap may be further reduced.

For a film layer structure on the CF side, following two design schemes may be adopted.

In scheme 1, a second post spacer layer PS2 is formed by using a Black Matrix layer (BM).

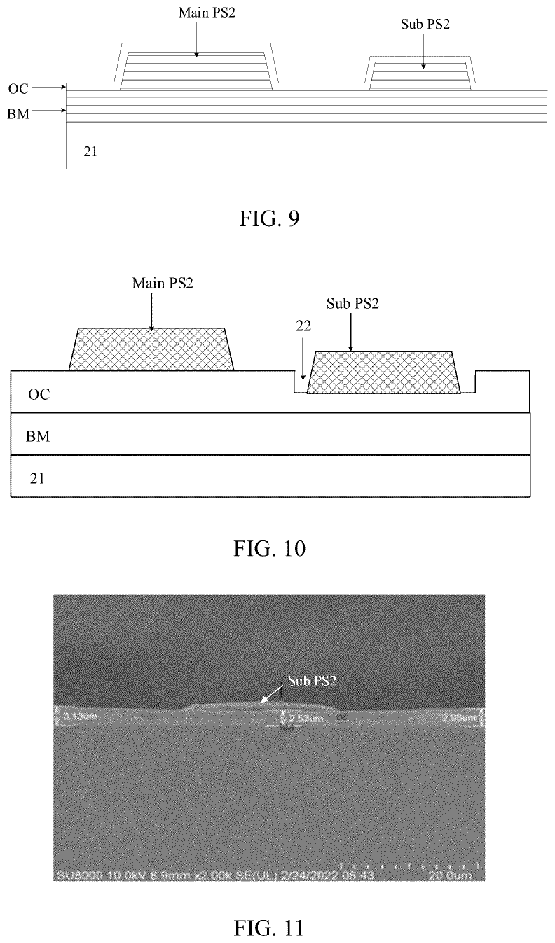

Referring to FIGS. 7 and 9, the second main post spacer Main PS2 and the second sub post spacer Sub PS2 include a Black Matrix layer (BM), and the color film substrate 20 includes an Over Coat (OC) covering the Black Matrix layer (BM) and the second substrate 21; in a direction perpendicular to the second substrate 21, a thickness of the Black Matrix layer (BM) is greater than a thickness of the Over Coat (OC) covered on the second substrate 21, and the Over Coat (OC) in the second main post spacer Main PS2 is butted against the first main post spacer Main PS1.

A common design of an XPS display panel is to deposit a layer of PS material on a TFT side and a CF side respectively to form a post spacer layer. However, in the display panel provided in the scheme 1, only one layer of PS material needs to be deposited on the TFT side, and a first post spacer layer PS1 is manufactured through a patterning process; but on the CF side, a second post spacer layer PS2 is formed by depositing a black matrix material thicker than a conventional one at a position opposite to the first post spacer layer PS1 on the second substrate 21. Among them, the Black Matrix layer (BM) and the Over Coat (OC) butted against the first main post spacer Main PS1 form a second main post spacer Main PS2, the Black Matrix layer (BM) and the Over Coat (OC) opposite to the first sub post spacer Sub PS1 form a second sub post spacer Sub PS2, and other black matrix layers (BM) may be normally used as shading structures. Therefore, the scheme 1 does not need to deposit a PS material on the CF side to form the second post spacer layer PS2, which may save a PS Mask process, reduce a manufacturing cost, and improve a production efficiency.

FIG. 9 shows a film layer structure of a second main post spacer Main PS2 and a second sub post spacer Sub PS2 formed by a Black Matrix layer (BM) and an Over Coat (OC). Among them, a height of the second post spacer layer PS2 on the CF side may be adjusted through a thickness of the Black Matrix layer (BM) and a thickness of the Over Coat (OC).

In some embodiments, the second main post spacer Main PS2 and the second sub post spacer Sub PS2 formed using the Black Matrix layer (BM) and the Over Coat (OC) may be equal in height or may be different in height, depending on whether a PS segment difference is formed on the TFT side or the CF side. Optionally, a difference between a sum of thicknesses of the Black Matrix layer (BM) and the Over Coat (OC) in the second main post spacer Main PS2 after cell-assembling and a height of the first main post spacer Main PS1 after cell-assembling is not more than 20%, that is, an equal height design or an approximate equal height design may be adopted for the first main post spacer Main PS1 and the second main post spacer Main PS2.

Considering that the first main post spacer Main PS1 formed by depositing a PS material will be compressed after cell-assembling, while the Black Matrix layer (BM) will hardly be compressed, for a liquid crystal display panel of XPS combined with COA of the scheme 1, it is satisfied that a sum of a product of a height of the first main post spacer Main PS1 before cell-assembling and a compression ratio after cell-assembling, and a height of the second main post spacer Main PS2, is equal to a liquid crystal cell gap, that is, as described below.

$$d = {H}_{1} \times k + {H}_{t} \qquad ( 11 )$$

In the above formula, d is a liquid crystal cell gap, and H₁ is a free height of the first main post spacer Main PS1 before cell-assembling, Hₜ is a height of the second main post spacer Main PS2, which is equal to a height of the Black Matrix layer (BM) after cell-assembling, or a sum of heights of the Black Matrix layer (BM)+the Over Coat (OC) after cell-assembling, k is a compression ratio of the first main post spacer Main PS1 after cell-assembling, and a value of k ranges from 0.86 to 0.88, for example, the value is 0.87.

It may also be seen from the formula (11) that a sum of a free height of the first main post spacer Main PS1 on the TFT side before cell-assembling or a height after disassembly and a height of the second main post spacer Main PS2 is greater than the liquid crystal cell gap d, that is, a thickness of an opening region. In addition, as shown in FIG. 7, the first main post spacer Main PS1 on the TFT side is disposed above a TFT device in a pixel region, which is beneficial to reduce a thickness of an opening region.

In some embodiments, a height PSH (H₁×k) of the first main post spacer Main PS1 on the TFT side after being compressed by cell-assembling, is equal to or approximately equal to Hₜ of the second main post spacer Main PS2 on the CF side, so as to ensure that a height of a PS layer on one side will not be too small to cause PS missing. Among them, being approximately equal may be that a deviation between a height PSH1 of the first main post spacer Main PS1 after cell-assembling and the height Hₜ of the second main post spacer Main PS2 after cell-assembling does not exceed 10%.

It should be noted that, if a height PSH of the first main post spacer Main PS1 on the TFT side is equal to or greater than 0.9 μm, and is consistent with a sum of thicknesses of the Black Matrix layer (BM) and the Over Coat (OC), i.e., a height of the second main post spacer Main PS2, then it is possible to have different heights between the first main post spacer Main PS1 and the first sub post spacer Sub PS1, and to form a PS segment difference on the TFT side. Since for a COA product, planarization may be performed on the array substrate 10 through the Colorresist Layer (CRL) and the Organic film layer (ORG), a pixel segment difference may not be considered for a position of the first post spacer layer PS1 on the TFT side and a position of a pixel opening region, and at this time, the liquid crystal cell gap may be controlled to not less than 1.56 μm.

In scheme 2, a PS material is deposited to form a second post spacer layer PS2.

Referring to FIG. 10, the color film substrate 20 includes a Black Matrix layer (BM) and an Over Coat (OC) disposed on a side of the second substrate 21 close to the array substrate 10, the Black Matrix layer (BM) is disposed between the second substrate 21 and the Over Coat (OC); the Over Coat (OC) is provided with a second groove 22, a second sub post spacer Sub PS2 is disposed within the second groove 22, and a second main post spacer Main PS2 is disposed on the Over Coat (OC) outside the second groove 22.

In some embodiments, a width or area of the Black Matrix layer (BM) is larger than that of the second post spacer layer PS2 on the CF side, and an orthographic projection of the second groove 22 on the second substrate 21 is located within an orthographic projection of the Black Matrix layer (BM) on the second substrate 21, i.e., the second groove 22 is located above the Black Matrix layer (BM). The second groove 22 may be a blind hole formed by digging a groove on the Over Coat (OC), or may be a through hole penetrating through the Over Coat (OC), and may be designed according to actual requirements. A post spacer material is deposited within the second groove 22 to form a second sub post spacer Sub PS2, and an orthographic projection of the second sub post spacer Sub PS2 on the second substrate 21 is located within the orthographic projection of the second groove 22 on the second substrate 21.

In some embodiments, in a vertical direction of the color film substrate 20 or in a thickness direction of the color film substrate 20, a top surface of the second sub post spacer Sub PS2 located within the second groove 22 is lower than a top surface of the second main post spacer Main PS2, that is, an upper surface of the second sub post spacer Sub PS2 is lower than an upper surface of a peripheral second main post spacer Main PS2, and a height difference between the two is about 0.45 μm to 0.55 μm, so that a PS segment difference is formed on the color film substrate 20 side, and a better value may be controlled at 0.5 μm, so that on one hand, the Halftone Mask may be no longer used, and the Normal Mask is used to manufacture a post spacer on the CF side, saving a production cost of a Mask; on the other hand, a design of the second main post spacer Main PS2 and the second sub post spacer Sub PS2 is supported to be lower, while further reducing the liquid crystal cell gap, PS missing caused by a too low height of the second sub post spacer Sub PS2 is avoided. The research shows that when a height of the second sub post spacer Sub PS2 is less than or equal to 0.5 μm, it is easy to cause a problem of PS missing. It should be noted that since a PS segment difference is formed on the color film substrate 20 side, a top surface of the first main post spacer Main PS1 and a top surface of the first sub post spacer Sub PS1 are designed to be equal in height in a vertical direction or thickness direction on the array substrate 10 side.

A micrograph of the second sub post spacer Sub PS2 may be referred to FIG. 11. The second sub post spacer Sub PS2 “stands” within a blind hole or trench of the Over Coat (OC), and a depth of the trench may be adjusted according to design requirements, so as to satisfy that a top surface of the second sub post spacer Sub PS2 is about 0.5 μm lower than a top surface of a peripheral second main post spacer Main PS2, just forming a PS segment difference. On this basis, an actual height of the second sub post spacer Sub PS2 may be designed to be equal to an actual height of the second main post spacer Main PS2 to ensure that the second sub post spacer Sub PS2 is not missing. At this time, lowest heights of the second main post spacer Main PS2 and the second sub post spacer Sub PS2 may be reduced to 0.6 μm, thereby significantly reducing the liquid crystal cell gap.

When heights of the first main post spacer Main PS1 and the second main post spacer Main PS2 are the same, the liquid crystal cell gap satisfies a following formula.

$$d = {H}_{1} \times 2 \times P S compression ratio \qquad ( 12 )$$

H₁ in the formula (12) is a free height of the first main post spacer Main PS1 on the TFT side before cell-assembling, and is equal to a free height of the second main post spacer Main PS2 before being compressed by cell-assembling.

At this moment, if the PS compression ratio is 0.87, d=0.6×2×0.87=1.044 μm, so that the liquid crystal cell gap d may be controlled to 1.044 μm at the lowest, that is, d>1.044 μm.

In general, an XPS-based liquid crystal display panel provided by the above embodiments has following characteristics.

1) The Colorresist Layer (CRL) is fabricated on one side of the array substrate 10, and planarization is performed in combination with the Organic film layer (ORG), an influence of a pixel segment difference does not need to be considered when designing the liquid crystal cell gap, and there is no influence of TFT Pillow, so that influencing factors of the liquid crystal cell gap are simplified, and the liquid crystal cell gap may be controlled at more than or equal to 1.56 μm.

2) The first groove 12 is disposed on the Organic film layer (ORG) on the TFT side, and the first sub post spacer Sub PS1 is formed within the first groove 12, or the second groove 22 is disposed on the Over Coat (OC) on the CF side, and the second sub post spacer Sub PS2 is formed within the second groove 22. Thus, it is achieved that in a case that actual heights of the first main post spacer Main PS1 and the first sub post spacer Sub PS1 on the TFT side are equal or similar and actual heights of the second main post spacer Main PS2 and the second sub post spacer Sub PS2 on the CF side are equal or similar, a PS segment difference is formed between a main post spacer Main PS and a sub post spacer Sub PS by means of the first groove 12 or the second groove 22. On one hand, the Normal Mask is used instead of the Halftone Mask to prepare a PS layer, thus saving a Mask manufacturing cost. On the other hand, the main post spacer Main PS and the sub post spacer Sub PS may be designed to be lower, which can further reduce the liquid crystal cell gap and avoid PS missing caused by a too low height of the Sub PS, and achieve reduction of the liquid crystal cell gap from 1.5 μm to 1.044 μm, which makes an XPS product break through existing limitations and be designed towards a direction of a higher refresh rate.

The above scheme provides a structural design of a COA substrate. For a common display panel in which a Colorresist Layer (CRL) (color light-filtering layer) is disposed on the CF side, a following design may be adopted.

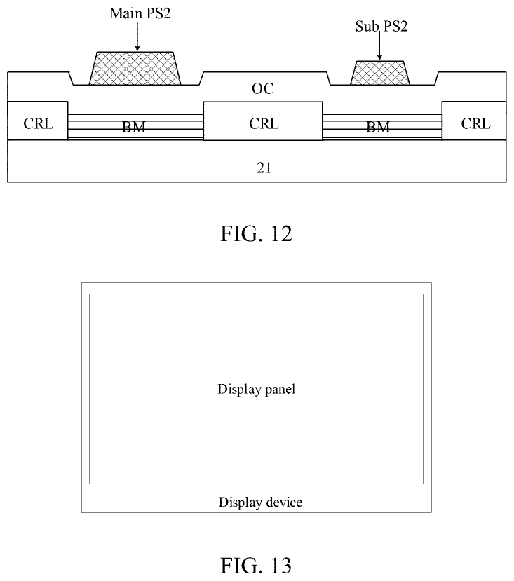

In some embodiments, referring to FIG. 12, the color film substrate 20 includes a Black Matrix layer (BM) and a Colorresist Layer (CRL) disposed in a same layer on the second substrate 21, and an Over Coat (OC) covering the Black Matrix layer (BM) and the Colorresist Layer (CRL); the second main post spacer Main PS2 and the second sub post spacer Sub PS2 are disposed in the Colorresist Layer (CRL), and an orthographic projection on the second substrate 21 is located within an orthographic projection of the Black Matrix layer (BM) on the second substrate 21; in a direction perpendicular to the second substrate 21, a sum of thicknesses of the Black Matrix layer (BM) and the Over Coat (OC) is smaller than a sum of thicknesses of the Colorresist Layer (CRL) and the Over Coat (OC).

The Black Matrix layer (BM) is disposed in a non-light transmission region of the color film substrate 20, the Colorresist Layer (CRL) is disposed in a light transmission region of the color film substrate 20, and the second main post spacer Main PS2 and the second sub post spacer Sub PS2 are disposed on the Over Coat (OC) directly above the Black Matrix layer (BM), and a bottom area of the second main post spacer Main PS2 and the second sub post spacer Sub PS2 is smaller than an area of the Black Matrix layer (BM) so as to avoid affecting light transmission adversely.

In the scheme, instead of digging a groove on the Over Coat (OC), a total thickness of the Black Matrix layer (BM) and the Over Coat (OC) at the second main post spacer Main PS2 and the second sub post spacer Sub PS2 are made thinner, so that it is smaller than a total thickness of the Colorresist Layer (CRL) and the Over Coat (OC) in a peripheral region, and at the same time, an overall height of the second post spacer layer PS2 is reduced and it is achieved that the liquid crystal cell gap is reduced, a groove digging process can also be saved.

In some embodiments, a thickness of the Over Coat (OC) directly above the Black Matrix layer (BM) is greater than a thickness of the Over Coat (OC) directly above the Colorresist Layer (CRL) outside a BM region, and the second main post spacer Main PS2 and the second sub post spacer Sub PS2 are disposed on the Over Coat (OC) directly above the Black Matrix layer (BM), which may make a structure under a post spacer more stable and not easy to peel off.

Optionally, the second main post spacer Main PS2 and the second sub post spacer Sub PS2 may also be disposed by digging a groove on the Over Coat (OC), which may also reduce an overall height of the second post spacer layer PS2, thereby reducing the liquid crystal cell gap.

It should be noted that in a structure adopted in the scheme, alignment layers are both disposed on upper and lower sides of a liquid crystal layer LC, and the alignment layers and the liquid crystal layer are all in direct contact. Since one alignment layer has a uniform thickness, the scheme is not shown in the figure, and its thickness is not considered. Its existence is ignored when describing the embodiment, but it does not mean that it does not really exist.

In a second aspect, referring to FIG. 13, the present disclosure provides a display device, including a display panel provided by the embodiment of the first aspect. The display device may be an electronic device with a display screen, such as a desktop computer monitor, an integrated computer, a notebook computer, a tablet computer, a conference integrated machine, and a smart phone.

Although some embodiments of the present disclosure have been described, those skilled in the art may make additional changes and modifications to these embodiments once basic creative concepts are known. Therefore, the appended claims are intended to be interpreted as including some embodiments and all changes and modifications falling within the scope of the present disclosure.

Apparently, various modifications and variations may be made to the present disclosure by those skilled in the art without departing from the spirit and scope of the present disclosure. Thus, if these modifications and variations to the present disclosure are within the scope of the claims of the present disclosure and their equivalent techniques, the present disclosure is also intended to include these modifications and variations.

1. A display panel, comprising an array substrate, a color film substrate, and a liquid crystal layer between the array substrate and the color film substrate;
wherein a liquid crystal cell gap of the liquid crystal layer in a light transmission region of the display panel satisfies:
when a refresh rate of the display panel is greater than or equal to 60 Hz and does not exceed 480 Hz, a reciprocal of the refresh rate of the display panel conforms to a quadratic polynomial relationship with the liquid crystal cell gap.

2. The display panel according to claim 1, wherein the liquid crystal cell gap and the refresh rate satisfy:
$$1 / f = {C}_{2} \times {d}^{2} + {C}_{1} \times d + {C}_{0} ;$$
f in the above formula is the refresh rate, and a unit is Hz; d is the liquid crystal cell gap, and a unit is μm; a value range of C₂ is 0.003 to 0.004, a value range of C₁ is −0.02 to −0.01, and a value range of C₀ is 0.01 to 0.02.

3. The display panel according to claim 1, wherein when the refresh rate of the display panel is greater than 480 Hz and does not exceed 1000 Hz, a value of the liquid crystal cell gap ranges from 1.044 μm to 1.6 μm.

4. The display panel according to claim 1, wherein the array substrate comprises a first substrate and a first post spacer layer, the first post spacer layer is disposed on a side of the first substrate close to the color film substrate; the color film substrate comprises a second substrate and a second post spacer layer, and the second post spacer layer is disposed on a side of the second substrate close to the array substrate;
the first post spacer layer comprises at least one first main post spacer and a plurality of first sub post spacers, wherein the first main post spacer and the first sub post spacers are disposed at intervals; the second post spacer layer comprises at least one second main post spacer and a plurality of second sub post spacers, wherein the second main post spacer and the second sub post spacers are disposed at intervals; the first main post spacer is butted against the second main post spacer, and the first sub post spacers and the second sub post spacers are disposed oppositely.

5. The display panel according to claim 4, wherein the array substrate further comprises a colorresist layer and an organic film layer stacked on the first substrate, and the organic film layer is located between the colorresist layer and the first post spacer layer.

6. The display panel according to claim 5, wherein the organic film layer is provided with a first groove, a first sub post spacer is disposed within the first groove, and the first main post spacer is disposed on the organic film layer outside the first groove.

7. The display panel according to claim 4, wherein the second main post spacer and the second sub post spacer comprise a black matrix layer, and the color film substrate comprises an over coat covering the black matrix layer and the second substrate; in a direction perpendicular to the second substrate, a thickness of the black matrix layer is greater than a thickness of the over coat covering the second substrate, and the over coat on the second main post spacer is butted against the first main post spacer.

8. The display panel according to claim 7, wherein a deviation between a sum of thicknesses of the black matrix layer in the second main post spacer, and the over coat after cell-assembling, and a height of the first main post spacer after cell-assembling, is not more than 20%.

9. The display panel according to claim 4, wherein the color film substrate comprises a black matrix layer and an over coat disposed on a side of the second substrate close to the array substrate, and the black matrix layer is located between the second substrate and the over coat;
the over coat is provided with a second groove, a second sub post spacer is disposed within the second groove, and the second main post spacer is disposed on the over coat outside the second groove.

10. The display panel according to claim 4, wherein the color film substrate comprises a black matrix layer and a colorresist layer disposed in a same layer on the second substrate, and an over coat covering the black matrix layer and the colorresist layer; the second main post spacer and the second sub post spacers are disposed on the over coat, and an orthographic projection on the second substrate is located within an orthographic projection of the black matrix layer on the second substrate;
in a direction perpendicular to the second substrate, a sum of thicknesses of the black matrix layer and the over coat is less than a sum of thicknesses of the colorresist layer and the over coat.

11. The display panel according to claim 4, wherein in a vertical direction of the color film substrate, top surfaces of the second sub post spacers are lower than a top surface of the second main post spacer, and height differences are 0.45 μm to 0.55 μm; or, in a vertical direction of the array substrate, top surfaces of the first sub post spacers are lower than a top surface of the first main post spacer, and height differences are 0.45 μm to 0.55 μm.

12. The display panel according to claim 4, wherein a sum of a product of a height of the first main post spacer before cell-assembling and a compression ratio after cell-assembling, and a height of the second main post spacer after cell-assembling, is equal to the liquid crystal cell gap, and a value range of the compression ratio is 0.86 to 0.88.

13. The display panel according to claim 4, wherein a deviation between a height of the first main post spacer after cell-assembling and a height of the second main post spacer after cell-assembling does not exceed 10%.

14. The display panel according to claim 4, wherein the first main post spacer and the first sub post spacers have a same height, and heights of the second sub post spacers are lower than a height of the second main post spacer; or,
the second sub post spacers and the second main post spacer have a same height, and heights of the first sub post spacers are lower than a height of the first main post spacer.

15. A display device, comprising a display panel according to claim 1.

16. A display device, comprising a display panel according to claim 2.

17. A display device, comprising a display panel according to claim 3.

18. A display device, comprising a display panel according to claim 4.

19. A display device, comprising a display panel according to claim 5.

20. A display device, comprising a display panel according to claim 7.
